(19) United States
(12) Patent Application Publication
(10) Pub. No.: US 2026/0121006 A1
(43) Pub. Date: Apr. 30, 2026

(54) SYSTEMS AND METHODS FOR CAPILLARY ISOELECTRIC FOCUSING-MASS SPECTROMETRY (CIEF-MS) ISOELECTRIC POINT (pI) CALIBRATION

(71) Applicant: DH Technologies Development Pte. Ltd., Singapore (SG)

(72) Inventor: Lyle Lorrence BURTON, Woodbridge (CA)

(21) Appl. No.: 18/841,615

(22) PCT Filed: Feb. 28, 2023
(86) PCT No.: PCT/IB2023/051854

§ 371 Date: Aug. 26, 2024

Related U.S. Application Data
(60) Provisional application No. 63/315,680, filed on Mar. 2, 2022.

(51) Int. Cl. H01J 49/00

(52) U.S. Cl. CPC H01J 49/0036; H01J 49/0009

(57) ABSTRACT

Systems and methods for calibrating compound markers in mass spectrometry (MS) detection are disclosed. The systems and methods automatically identify a plurality of isoelectric point (pI) markers in a sample, generate a calibration curve correlating pI with time, and convert the time scale to a pI scale. Based on the established correlation between time and pI, the system further associates pI with intensity values, enabling presentation to an operator for analysis.

### RELATED APPLICATIONS

The present patent application claims the priority benefit of U.S. Provisional Patent Application Ser. No. 63/315,680, filed Mar. 2, 2022, the content of which is hereby incorporated by reference in its entirety into this disclosure.

### BACKGROUND

Mass spectrometry is an analytical technique that measures mass-to-charge (m/z) ratio of ions. The results are presented as a mass spectrum, typically as a plot of intensity as a function of the mass-to-charge ratio. However, these results often fail to provide some information to operators that can aid in identifying properties of a sample. Accordingly, systems and methods to enhance the results of MS analysis, and the presentation thereof, is desirable.

### SUMMARY

The inventors have recognized the need for enhanced results of MS analysis. A solution is disclosed herein, as systems and methods are provided to perform calibration of isoelectric point (pI) markers in mass spectrometry (MS) detection. In particular, a method is disclosed to generate an output that includes one or more pI markers associated with a sample from MS data acquired for the sample. From the output, one or more pI markers are identified, as are an isotope or a charge state associated with the one or more pI markers. Time values (which are present in the results of MS analysis) are correlated to the identified one or more pI markers based on the identified isotope or charge state, which can then be presented to an operator in graphical form. For instance, a graphical representation can be presented to the operation, with pI on the X-axis versus intensity on the Y-axis, thereby providing more relevant and meaningful information to the operator.

One aspect of the disclosure relates to a method for performing calibration of isoelectric point (pI) markers in mass spectrometry (MS) detection. In examples, the method includes generating an output that includes one or more pI markers associated with a sample from MS data acquired for the sample, identifying the one or more pI markers in the output, identifying one or more of an isotope or a charge state associated with the one or more pI markers, and correlating time values to the identified one or more pI markers based on the identified isotope or charge state.

In one aspect, the method includes spiking the sample with the one or more pI markers associated with one or more reference compounds.

In another aspect, the method further includes generating a graphical representation of the identified one or more pI markers along a first axis versus intensity along a second axis according to the correlated time values, and displaying the graphical representation on a user interface.

In one aspect, identifying the one or more of the isotope or the charge state associated with the one or more pI markers further includes extracting XIC values for the isotope or the charge state.

In one aspect, correlating a plurality of peaks in MS analysis data with one or more of the identified isotope or the charge state with one or more of the time values.

In one aspect, the pI marker corresponds to an overlapping peak of one or more traces associated with a compound. In one aspect, identifying the one or more pI markers in the output further includes identifying one or more peaks of the plurality of peaks associated with the one or more pI markers in alignment with another peak of the plurality of peaks, and identifying a first pI marker of the one or more pI markers based on a time or intensity value corresponding to the aligned peaks.

In another aspect, identifying one or more peaks of the plurality of peaks associated with the one or more pI markers out of alignment with other peaks of the plurality of peaks, and removing the one or more pI markers corresponding to the one or more peaks out of alignment from the output.

In one aspect, alignment is determined by comparing the time or the intensity values corresponding to the peaks to one or more alignment threshold amounts.

Another aspect of the disclosure relates to a method for performing calibration of compound markers in mass spectrometry (MS) detection, the method includes performing MS analysis on a sample, generating an output that includes one or more compound markers associated with the sample, identifying the one or more compound markers in the output, identifying one or more of an isotope or a charge state associated with the one or more compound markers, and correlating time values to the identified one or more compound markers based on the identified isotope or charge state.

In one aspect, the method includes spiking the sample with peptide markers or one or more compound markers associated with one or more reference compounds.

In one aspect, the method includes applying one or more filters to identify one or more outlier peaks in the output, and removing the one or more outlier peaks from the output prior to identification of the one or more pI markers.

In another aspect, the method includes displaying the isotope or the charge state associated with the identified one or more pI markers or the one or more compound markers in the graphical representation according to the correlated one or more time values.

In another aspect, the one or more reference compound markers or the one or more pI markers comprises one or more calibration peptides.

In another aspect, the sample contains one or more proteins.

In another aspect, the method employs a capillary isoelectric focusing-mass spectrometry (CiEF-MS) device.

In another aspect, the method includes employs a Capillary electrophoresis-mass spectrometry (CE-MS) device.

Another aspect of the disclosure relates to a capillary isoelectric focusing-mass spectrometry (CiEF-MS) device coupled to a processing system for performing calibration of isoelectric point (pl) markers. In examples, the device includes control circuitry configured to activate the CiEF to perform analysis on a sample, activate the MS to perform MS analysis on a sample, receive output MS data corresponding to the MS analysis, identify one or more pI markers in the output data associated with the sample, identify one or more of an isotope or a charge state associated with the one or more pI markers, and correlate time values to the identified one or more pI markers based on the identified isotope or charge state.

In one aspect, the device includes a user interface configured to display a graphical representation of the identified one or more pI markers along a first axis according to the correlated time values and intensity values associated with the one or more pI markers along a second axis.

In one aspect, the pI marker corresponds to an overlapping peak of one or more traces associated with the sample.

Other aspects and features of the present disclosure will become apparent to those ordinarily skilled in the art upon review of the following description of specific embodiments of the disclosure in conjunction with the accompanying figures.

### BRIEF DESCRIPTION OF THE FIGURES

Embodiments of the present disclosure will now be described, by way of example only, with reference to the attached Figures.

FIGS. 1A and 1B illustrate output of a conventional MS result and a calibrated result, respectively, in accordance with aspects of this disclosure.

FIG. 2 illustrates an example trace with a marker peptide identified, in accordance with aspects of this disclosure.

FIG. 3 illustrates four example traces with marker peptides identified, in accordance with aspects of this disclosure.

FIG. 4 illustrates a different range of the four example traces of FIG. 3, in accordance with aspects of this disclosure.

FIG. 5 illustrates an example pI calibration curve, in accordance with aspects of this disclosure.

FIG. 6 illustrates an example pI calibration curve containing an error, in accordance with aspects of this disclosure.

FIG. 7 illustrates an initial view of a trace with migration time along the X-Axis and intensity along the Y-axis, in accordance with aspects of this disclosure.

FIG. 8 illustrates an example user interface, in accordance with aspects of this disclosure.

FIG. 9 illustrates an example user interface(s) presenting an output of the MS analysis, in accordance with aspects of this disclosure.

FIG. 10 illustrates a detailed view of the calibration curve of the top left panel in FIG. 9, in accordance with aspects of this disclosure.

FIG. 11 illustrates a summary table with a tabular view of the plot from FIG. 9, in accordance with aspects of this disclosure.

FIG. 12 illustrates aligned traces for a first marker of five peptides, in accordance with aspects of this disclosure.

FIGS. 13-16 illustrate second through fifth markers of the five peptides, respectively, in accordance with aspects of this disclosure.

FIG. 17 illustrates a full range of the fourth marker of FIG. 12, in accordance with aspects of this disclosure.

FIG. 18 illustrates the peak of the fourth marker of FIG. 12 out of alignment, in accordance with aspects of this disclosure.

FIG. 19 illustrates a result of an example calibration operation presented as a graph with pI along the X-axis and intensity along the Y-axis, in accordance with aspects of this disclosure.

FIG. 20 provides a flowchart illustrating an example calibration operation, in accordance with aspects of this disclosure.

FIG. 21 provides an example a mass spectrometer (MS) and control circuitry, in accordance with aspects of this disclosure.

The figures are not necessarily to scale. Where appropriate, the same or similar reference numerals are used in the figures to refer to similar or identical elements.

### DETAILED DESCRIPTION

It is to be understood that this disclosure is not limited to the particular systems, device, methodology, and/or protocols described herein and as such may vary. It is also to be understood that the terminology used herein is for the purpose of describing particular embodiments only and is not intended to limit the scope of the present disclosure or the appended claims.

Systems and methods for performing calibration of compound markers in mass spectrometry (MS) detection are presently claimed and described. The example systems and methods provide for automatic identification of all or substantially all pI markers in a sample, constructing a calibration curve of pI and time, and/or converting the time scale into pI scale. Given the correlation between the time and pI scales, pI can be correlated to intensity and presented to an operator for further analysis.

In some MS systems, calibration of traces from multiple runs is most commonly done from separate UV trace data. In particular, if markers are chosen to have strong UV absorption this provides useful information for identification of such markers. However, for complex samples, finding accurate peaks in a single UV trace is challenging. It may also require UV to be acquired simultaneously with the MS data, which may require additional hardware and/or software.

Conventional methods for converting a time scale to a pI scale in Capillary Isoelectric Focusing (CiEF) assays with MS detection rely on a manual search for pI markers on an MS electropherogram, followed by the construction of a calibration curve. The process is time consuming, and can be very complicated, such as when m/z ratio values of pI markers are very close to those for other (often unknown) compounds in the mixture.

The disclosed systems and methods provide for automatic identification of all or substantially all pI markers in a sample, constructing a calibration curve of pI and time, and/or converting the time scale into pI scale. Given the correlation between the time and pI scales, pI can be presented relative to intensity (which is associated with time in the MS data).

Thus, the disclosed systems and methods identify the calibrant along measurement axes (time) and calibrate time-pI in an automated fashion. The calibrated pI information can then be correlated with intensity values and presented in graphical form, for example. Accordingly, systems and methods to calibrate only from MS data would be more desirable, such as via automatic selection of relevant peaks and/or times.

As described above and provided in detail herein, the disclosed systems and methods provide advantages over conventional approaches. For example, the correlation methods allow for automatic pI calibration, for predetermined, unknown, and/or complex samples. Advantageously, this calibration provides substantial time savings by elimination of (often manual) steps to select the calibration markers. In some examples, the systems and methods are fully automated (via software instructions), such that manual review and/or corrections (such as removal of outliers) is not needed.

As used herein, “isoelectric point” or pI refers to the pH at which a molecule carries no net electrical charge or is electrically neutral in the statistical mean.

As used herein, “peptide” refers to a short chain of amino acids linked by peptide bonds.

As used herein, “protein” refers to a naturally occurring, extremely complex substance that consists of amino acid residues joined by peptide bonds.

As used herein, “capillary” refers to a channel, tube, or other structure capable of supporting a volume of separation medium for performing electrophoresis. Capillary geometry can vary and includes structures having circular, rectangular, or square cross-sections, channels, groves, plates, etc. that can be fabricated by technologies known in the art. Capillaries of the present disclosure can be made of materials such as, but not limited to, silica, fused silica, quartz, silicate-based glass such as borosilicate glass, phosphate glass, or alumina-containing glass, and other silica-like materials. In some aspects, the methods can be adapted and used in any generally known electrophoresis platform such as, for example, electrophoresis devices comprising single or multiple microfluidic channels, etched microfluidic capillaries, as well as slab gel and thin-plate gel electrophoresis.

As used herein, “capillary isoelectric focusing” or CiEF refers to a family of electrokinetic separation methods performed in small diameter capillaries and in micro-and nano-channels.

As used herein, “Capillary electrophoresis-mass spectrometry” or CE-MS refers to an analytical chemistry technique formed by the combination of the liquid separation process of capillary electrophoresis with mass spectrometry.

As used herein, an “electropherogram” refers to a series of peaks that can be converted to determine size and/or quantity of a sample. Peaks are integrated for area as a measure of quantity, and can be corrected for mobility differences between different sized peaks. In some aspects, when the biomolecules are nucleic acids, a nucleic acid ladder comprising nucleic acid fragments of known size can be run before, during, or after sample(s) of interest.

As used herein, “extracted ion chromatograms (XIC)” refers to a fundamental signal unit in mass spectrometry, such that one or more mass-to-charge (m/z) ratio values representing one or more analytes of interest are recovered (or “extracted”) from a data set corresponding to a chromatographic run. Such information can be used to detect unidentified analytes, to identify isomers, identify co-eluting substances, and/or graph chromatograms of compounds. XIC data is generated by separating ions of interest from full mass spectrum data over time after a chromatographic run (versus selected-ion chromatograms, in which specific m/z values are collected).

The terms “control circuit,” “control circuitry,” and/or “controller,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards that form part or all of a controller, and are used to control a welding process, a device such as a power source or wire feeder, and/or any other type of welding-related system.

As used herein, the term “processor” means processing devices, apparatus, programs, circuits, components, systems, and subsystems, whether implemented in hardware, tangibly embodied software, or both, and whether or not it is programmable. The processor may be coupled to, and/or integrated with a memory device.

As used, herein, the term “memory” and/or “memory device” means computer hardware or circuitry to store information for use by a processor and/or other digital device.

As used herein and in the appended claims, the singular forms “a,” “an,” and “the” include plural reference unless the context clearly indicates otherwise.

Unless defined otherwise, all technical and scientific terms used herein have the same meaning as commonly understood to one of ordinary skill in the art to which this disclosure belongs.

When performing isoelectric focusing of proteins coupled to a mass spectrometer (MS), the proteins are eluted from the capillary after focusing as a function of time so proteins can be introduced into the MS system. For instance, proteins with large isoelectric point (pI) elute first, and the result is likely substantially linear relationship between the elution or migration time and pl. However, traces representing the proteins are presented in graphical or numerical form, with time relative to intensity of the protein.

A more useful relationship would be presentation of pI relative to intensity. In particular, presentation of a graphical representation of pI on the X-axis versus intensity on the Y-axis provides more relevant and meaningful information to an operator.

In order to correlate pI to intensity, the present disclosure provides systems and methods to calibrate one or more traces associated with a sample to realign peaks associated with compounds of interest with pI rather than time.

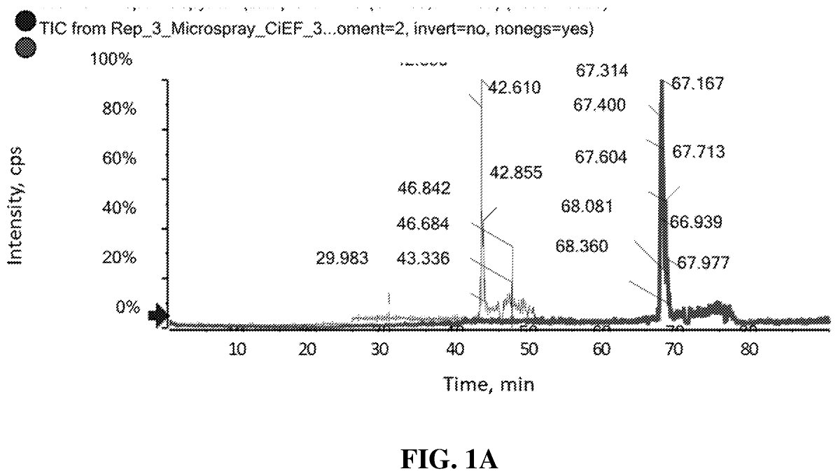

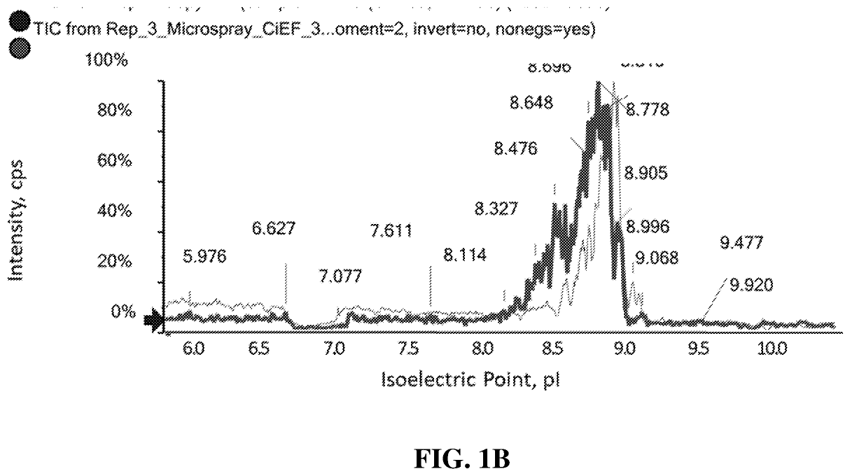

In particular, pI differences are relevant and meaningful to analysis of a sample, separate and apart from time values of a particular run. Additionally, the absolute time to complete such a run can be variable, making comparison between two or more runs difficult-for an operator and/or a software algorithm. For example, in the example of FIG. 1A, two runs with substantially different detection times are shown, with time versus intensity.

By contrast, FIG. 1B shows the same data after time data conversion to pI and arrangement of pI on the X-axis. The information presented in FIG. 1B shows substantial alignment of the data associated with the different runs, providing a much more informative comparison for an operator. In particular, the pI associated with various peaks corresponds to properties of the sample of interest, whereas timing data for each run is variable and may not reflect any particular sample property.

In order to find the time corresponding to any marker, multiple XICs should be extracted and processed for the isotopes and expected charge states of those isotopes. The selected time should correspond to the location where there is a peak in all (or a substantial portion) of the XICs at the same location. Since relevant isotopes and/or charge states are known in advance, mapping peaks can be done using a variety of approaches. For example, one or more XICs may be multiplied and the time for the most intense data point selected. More sophisticated approaches originally developed for SWATH MS/MS peak-group finding may also be employed.

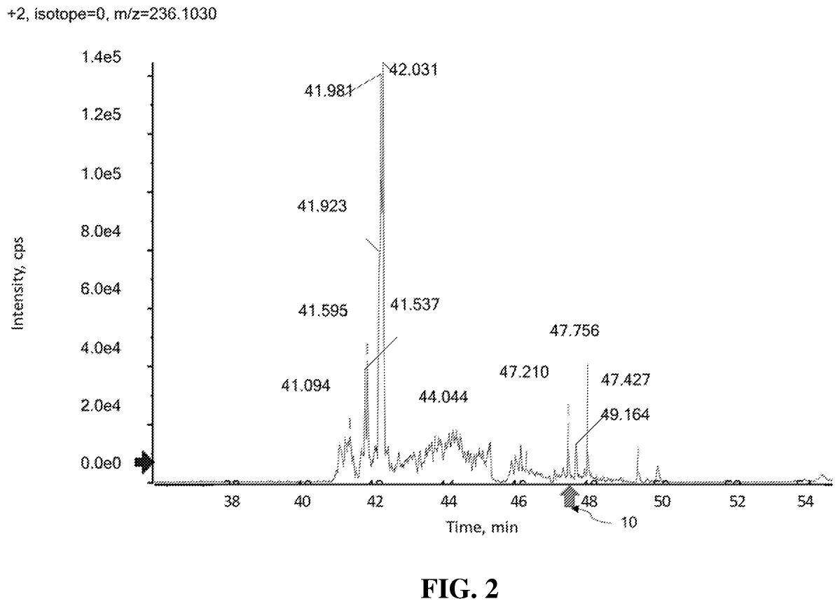

In order to perform the time to pI calibration, experimental migration times for markers of known pI (usually peptides) are located. However, for sample data containing noise or outliers, it can be difficult to reliably find such markers in XICs. For example, and as shown in FIG. 2, the marker peptide is indicated with arrow 10 near approximately 47.2 minutes. In the example of FIG. 2, several other interfering peaks are nearby, yet are not associated with the marker. The disclosed systems and methods provide a more focused peak detection and/or identification, which can be done with improved results.

In some examples, calibration peptides or markers of a particular sample will be pre-identified. Relevant charge states and isotopes can be determined in advance and applied to an output (e.g., a trace and/or results of a MS operation). However, when calibration peptides are not pre-identified, the relevant isotopes can be determined by comparing the output to one or more isotopes with a theoretical abundance greater than a specified fraction of the base peak presented in the analytical output.

In some examples, the correct or corresponding peak and/or time is found automatically for a substantial number or all marker peptides. However, for complex samples there may be some unidentified peaks. In some examples, calibration can be made more robust by removing outliers, be it automatically (e.g., via software) and/or by aid of an operator (e.g., manually).

A calibration process may be performed on-demand and/or automatically, such as based on a given trigger (e.g., timing, following an analytical process, etc.). The calibration data may be presented to an operator via one or more user interfaces (UI), such as a graphical representation of the output with the pI along the X-axis and intensity along the Y-axis. Although the original data may be stored, the original timing information need not be presented to the operator.

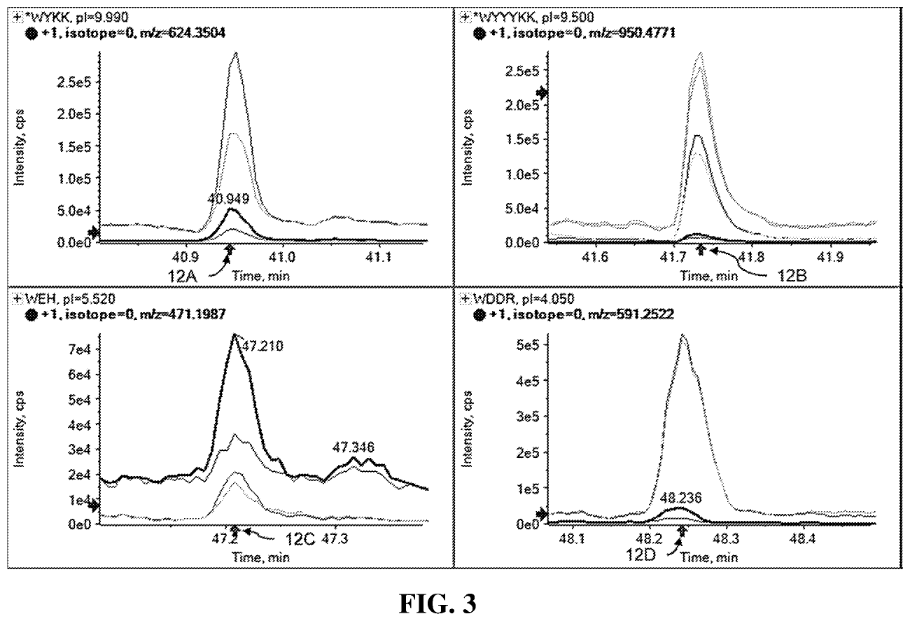

Turning to FIG. 3, four marker peptides are provided. In each of the four panels the specified charge states and (automatically identified and/or selected) isotopes are overlaid. The arrows 12A-12D mark the position of the time corresponding to the apex in a trace obtained by multiplying all traces in each panel together. In some cases, as illustrated in FIG. 3, the correct peak is identified, and alignment of the traces is reasonably consistent with time values.

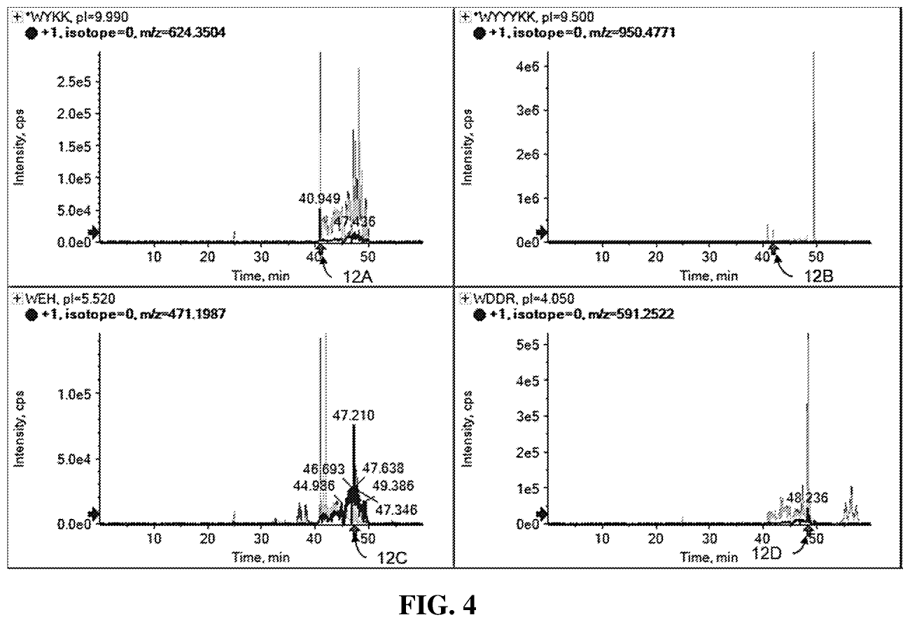

FIG. 4 shows the same data as provided in FIG. 3, but with a full range along the time, or X, axis. As shown, the correct time (identified by arrows 12A-12D) does not necessarily correspond to the simple maximum of any one trace. For example, in the top-right panel the peptide of interest is at about 41.7 minutes, very different from the large peak nearer 50 minutes.

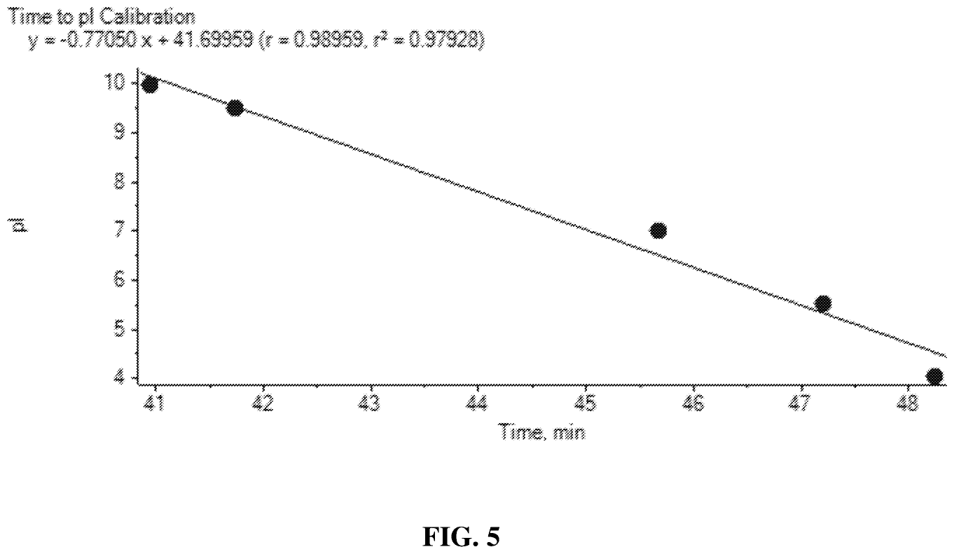

FIG. 5 shows the pI calibration curve, which was obtained using the time values (identified by arrows 12A-12D) identified in the FIGS. 3 and 4 (e.g., corresponding to pre-identified pI for each peptide of interest). In some examples, such as the one illustrated in FIG. 5, a substantially linear calibration curve provides a useful correlation (via co-efficient of a linear fit, as shown), although other functions (e.g., mathematical and/or graphical) could also be employed.

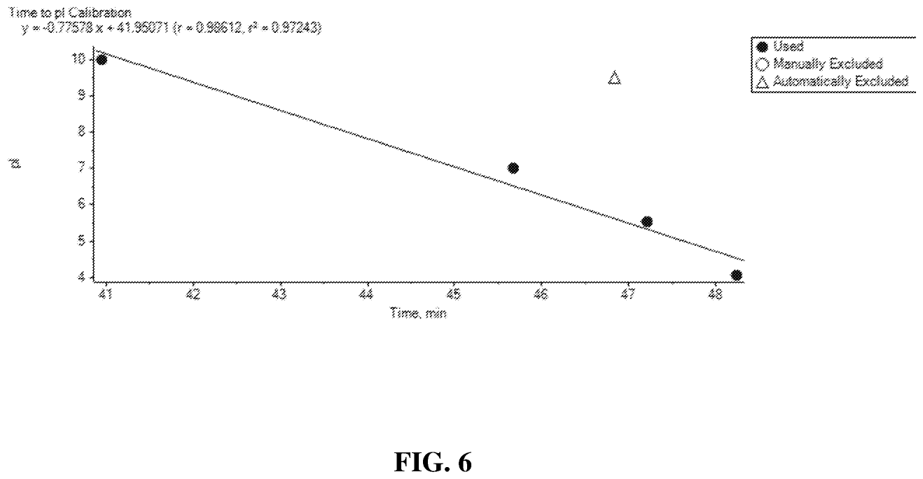

FIG. 6 shows an example calibration curve containing an error. As provided herein, the system is configured to automatically detect and/or remove such an outlier, while being able to determine a suitable calibration curve. Provided that a sufficient number of markers are in the data set, automatic determination of the calibration curve is possible, even for complex samples (e.g., multiple outliers can be detected and removed). In some examples, an identified outlier can be presented to the operator for consideration, such as to verify its removal.

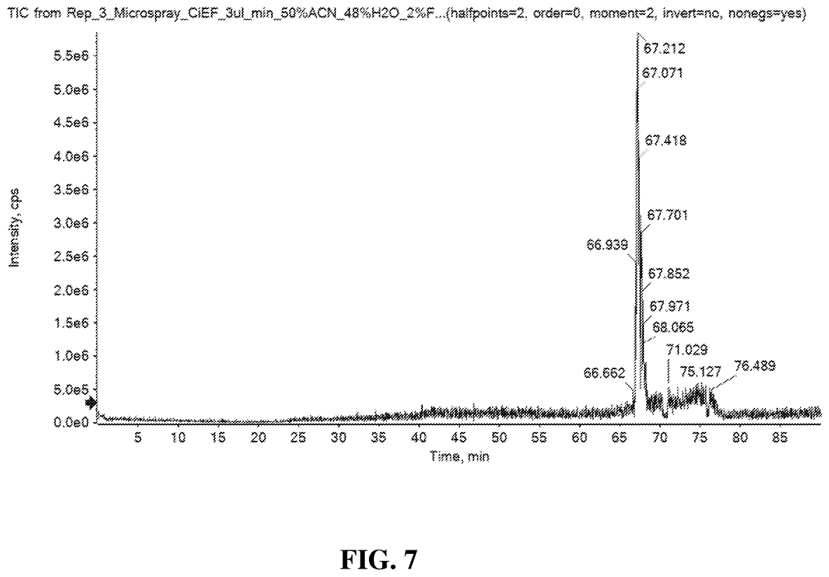

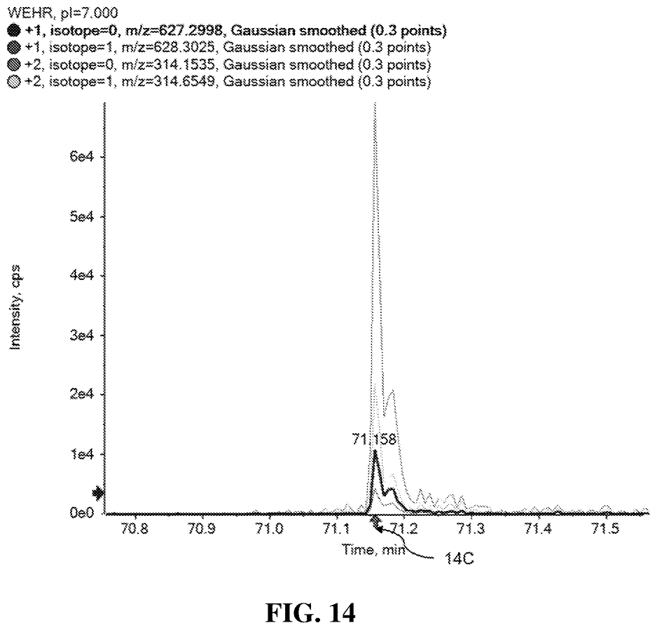

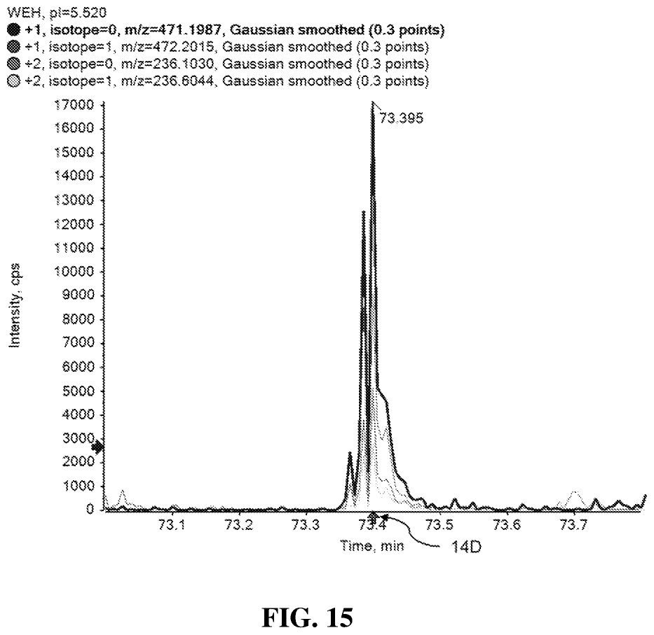

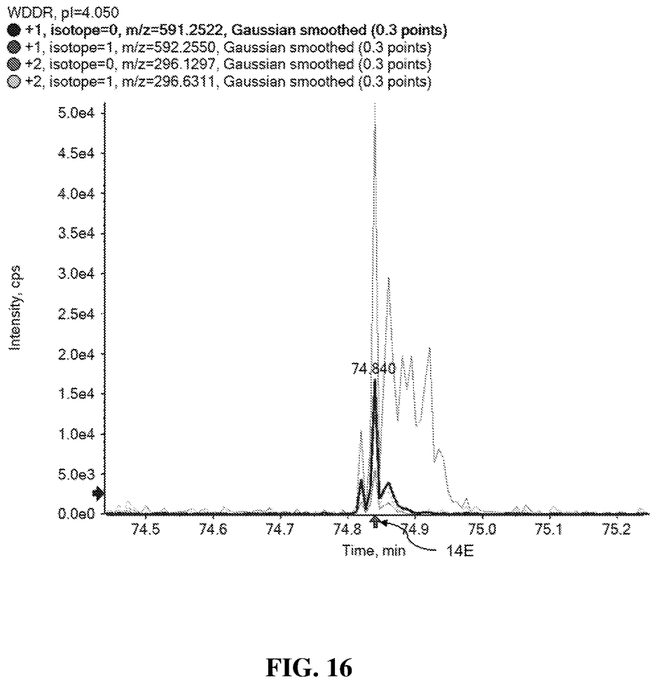

Turning now to FIGS. 7 to 19, a detailed view of automatic analysis of trace data and corresponding peptide markers. As shown in FIG. 7, an initial view of a trace with migration time along the X-axis with intensity along the Y-axis.

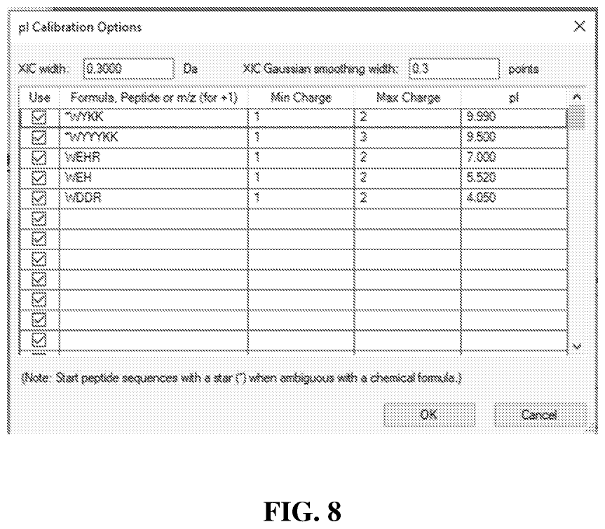

FIG. 8 shows an example user interface with information for specifying peptide sequences for marker peptides and corresponding known pI.

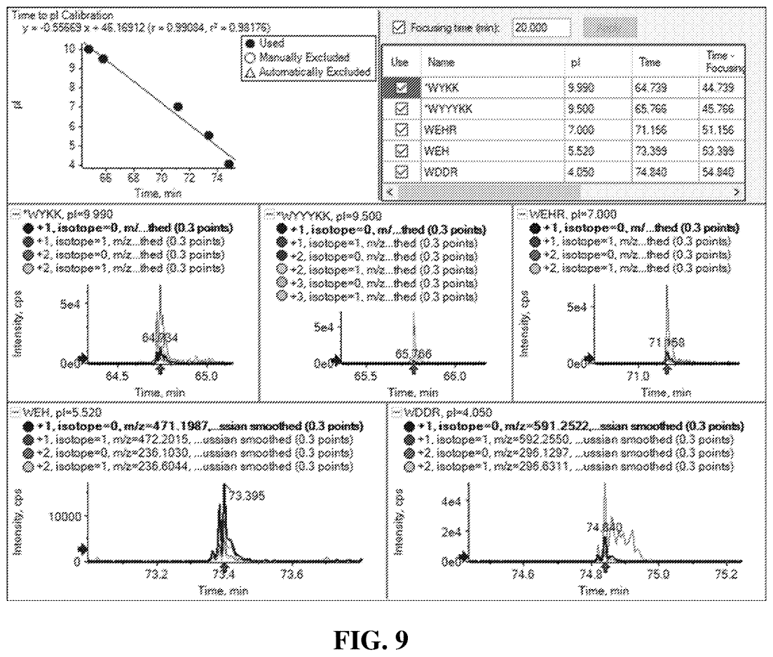

FIG. 9 illustrates an example user interface(s) presenting an output of the MS analysis. For example, several peaks are shown in middle and lower panels, with the time values identified at peak alignment. The top right panel provides a listing of peptides and associated pI, time, and time-focusing values, whereas the top left panel illustrates a calibration curve, as disclosed herein. Although this data may be compiled, stored, and/or employed to calibrate pI and time values, the illustrated user interface and data thereon may not necessarily be presented to an operator.

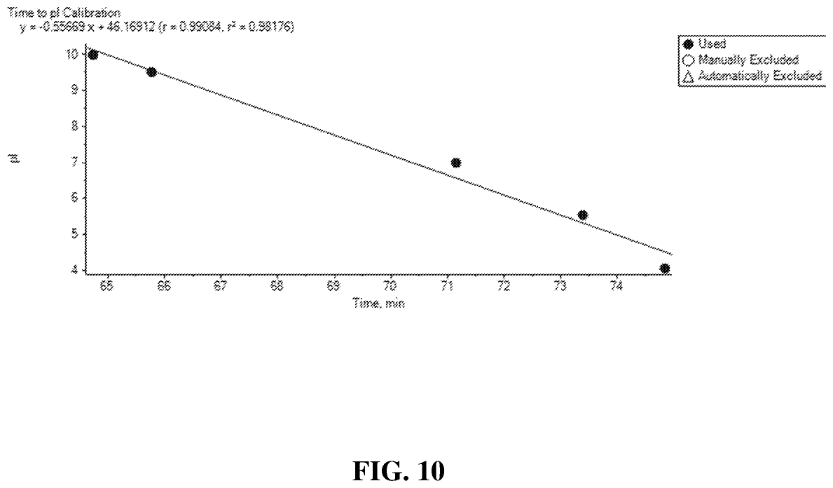

FIG. 10 shows a detailed view of the calibration curve of the top left panel in FIG. 9. For example, time to pI calibration is graphed, with time correlated to pI. Of note, the example calibration curve is reasonably linear, with no outlier data points for removal.

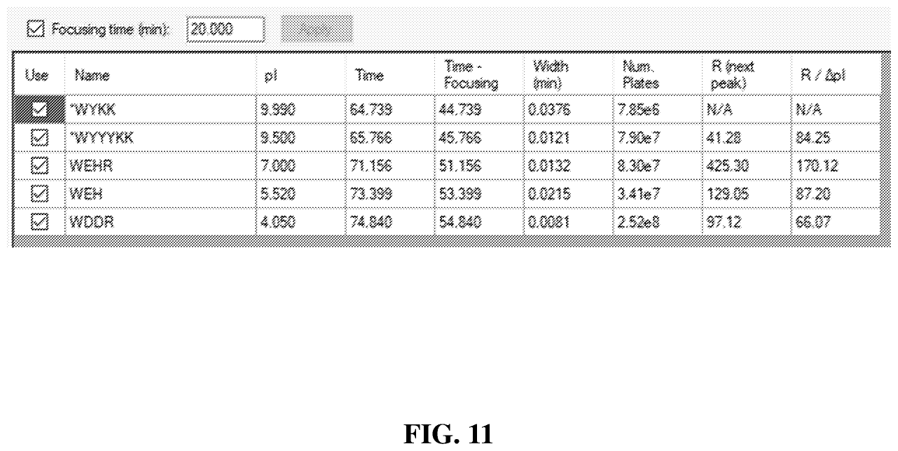

FIG. 11 shows a summary table with a tabular view of the plot from FIG. 9, along with additional fields of interest including width (the LC/MS peak width in minutes), num. plates (the number of theoretical chromatographic plates), R (next peak-e.g., the resolution between adjacent pairs of markers), and R/ΔpI (the relative resolution per pI unit).

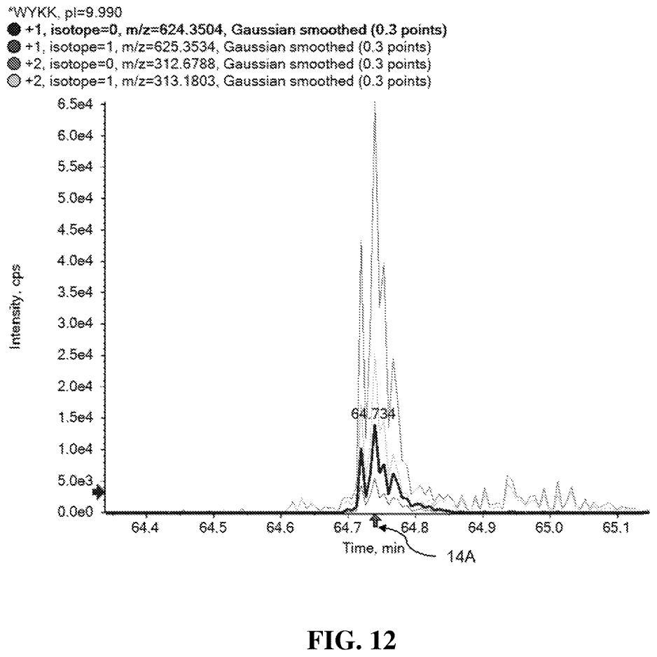

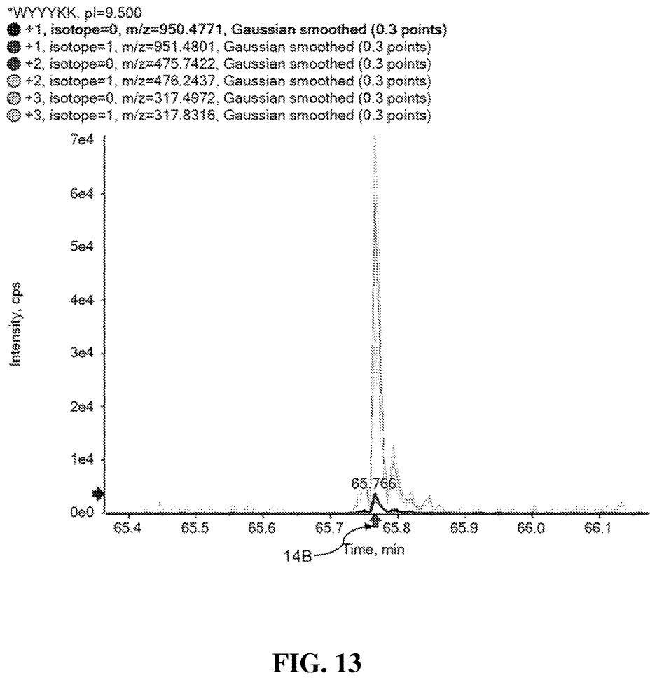

FIG. 12 shows aligned traces for a first marker of the five peptides, focused at 64.734 minutes (identified by arrow 14A) to show a selected, and correct, peak. FIGS. 13-16 show the second through fifth markers of the five peptides, focused at 65.766 minutes (identified by arrow 14B), 71.158 minutes (identified by arrow 14° C.), 73.395 minutes (identified by arrow 14D), and 74.840 minutes (identified by arrow 14E), respectively.

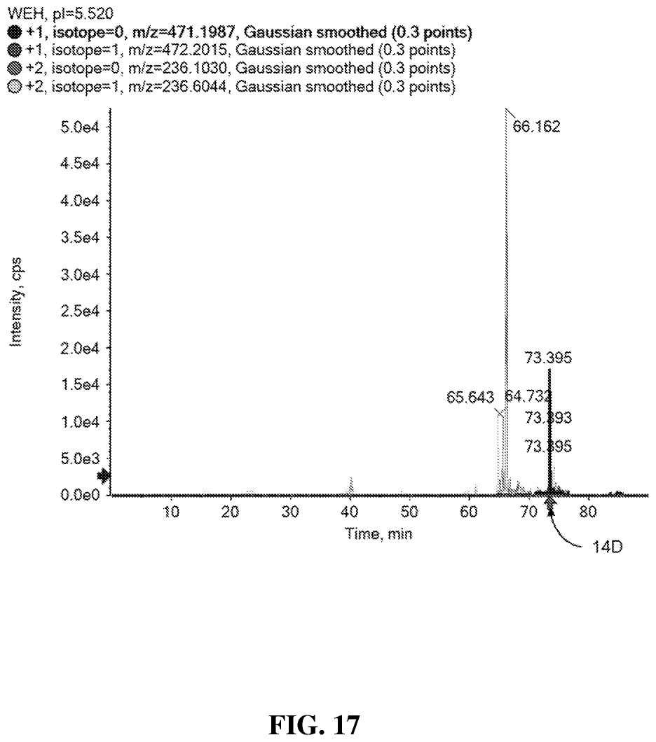

FIG. 17 shows a full range of the fourth marker peak with arrow 14E at 73.39 minutes. The fourth marker has been identified by the method disclosed herein and, despite numerous other peaks, is the correct one. For example, other traces are prominent, such as the peak near 66.162 minutes which is substantially bigger than the peak at 73.39 minutes. However, the peak near 66.162 minutes is not consistently present in all traces.

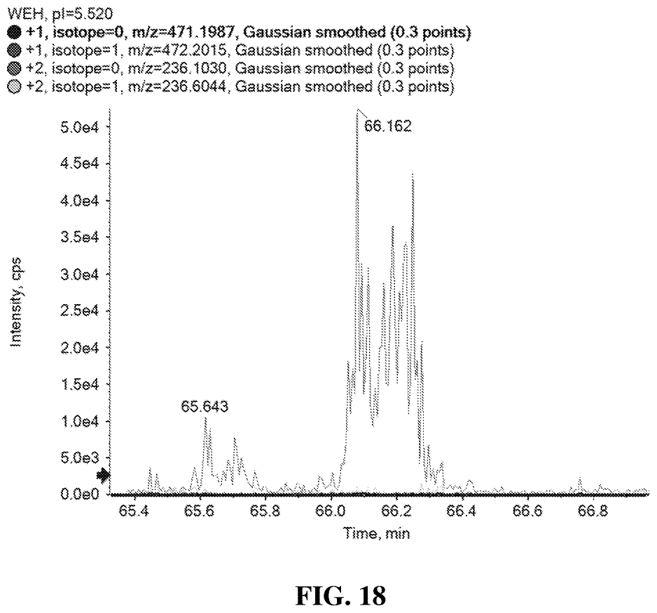

For instance, as shown in detail in FIG. 18, the peak of the fourth marker at 66.162 minutes does not align with any other marker. As shown, the peak at 66.162 minutes is bigger for only a single trace; only very small signals for other traces appear at a similar time. Thus, this peak does not correspond to a peptide of interest and therefore is not identified by employing the method.

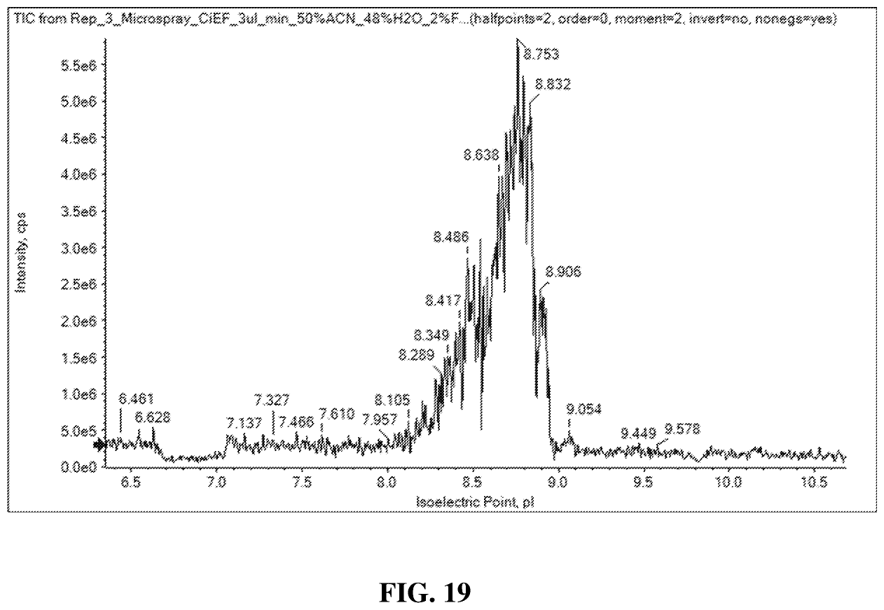

FIG. 19 illustrates a result of the calibration presented as a graph with pI along the X-axis and intensity along the Y-axis. Reported tabulated peaks (not shown) can now be labelled with pI rather than time.

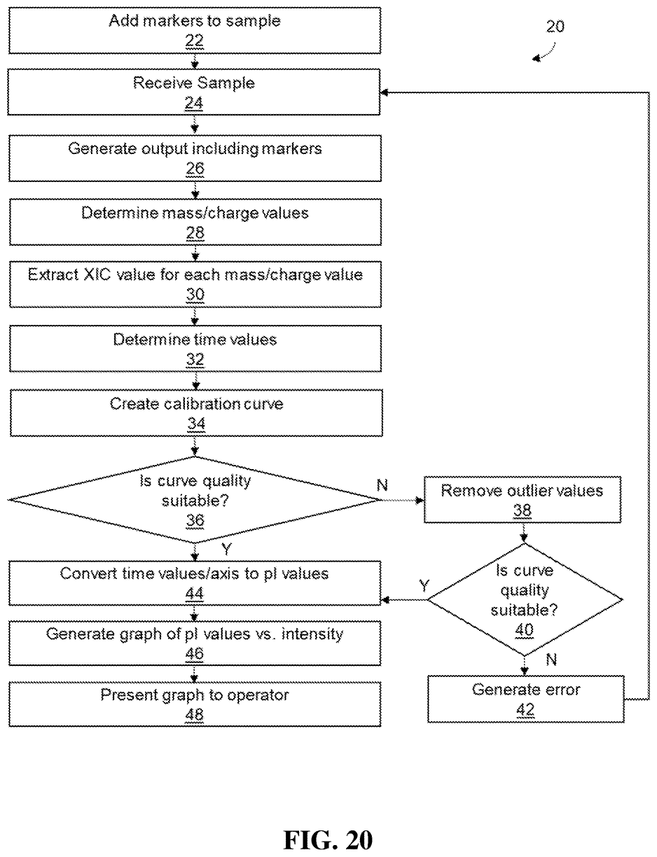

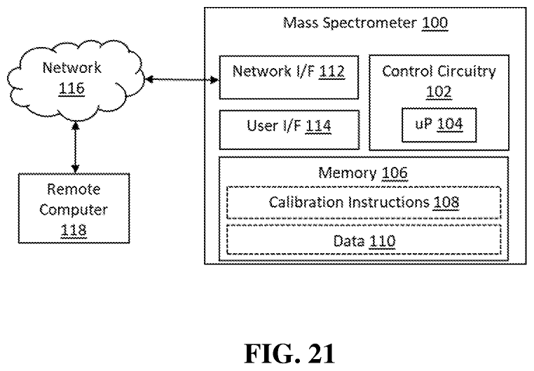

FIG. 20 is a flowchart representative of a program 20. For example, the program 20 may be stored on a memory (e.g., memory circuitry 106 of FIG. 21) linked to processor (e.g., processor 104 of FIG. 21) as a set of instructions (e.g., calibration instruction 108 of FIG. 21) to perform calibration of isoelectric point (pI) markers in mass spectrometry (MS) detection via associated circuitry (e.g., control circuitry 102 of FIG. 21), as disclosed herein.

At block 22, a sample is spiked with one or more markers (e.g., calibration peptides or other reference compounds). At block 24, the program 20 receives the sample for MS detection (e.g., at MS 100 of FIG. 21). At block 26, an output is generated that includes the one or more markers (pI markers) associated with MS data performed on the sample.

At block 28, mass/charge values associated with each of the one or more markers (for the multiple charge states and/or isotopes) are determined. For example, the values can be identified by comparison with a listing or look-up table (e.g., data 110), and/or calculated (e.g., employing one or more algorithms or instructions 108). At block 30, XIC values for each of the mass/charge values are extracted from the output.

At block 32, a time for each of the one or more markers is determined using traces provided in the output. For example, the likely time value may correspond to a position of maximum peak overlap for different traces (e.g., the corresponding isotope and/or charge m/z for the given marker). For example, the pI markers may correspond to an overlapping peak of one or more traces associated with a compound. Thus, one or more peaks of the plurality of peaks associated with the one or more pI markers are in alignment with another peak of the plurality of peaks (such as from multiple traces). This can be accomplished by identifying a first pI marker of the one or more pI markers based on a time or intensity value corresponding to the aligned peaks. In some examples, the time and/or the intensity values corresponding to the peaks are compared to one or more alignment threshold amounts to determine alignment of the peaks. In some additional or alternative examples, the control circuitry can generate a graph with the XIC values and present them to the operator for manual confirmation or correction.

At block 34, a calibration curve is created employing the times values determined in block 32 along with known pI values (e.g., associated with the one or more markers.). For instance, the calibration curve is typically linear.

At block 36, a quality of the calibration curve is determined based on one or more characteristics of data points associated with the one or more markers (e.g., correlation co-efficient of a linear fit). For instance, if the quality of the linear fit is poor in view of the characteristics (e.g., a time determined in 34 falls outside an acceptable range of variance and/or determined to not be correct), the most problematic point(s) (e.g., with the greatest variance from the calibration curve) can be removed from the fit, curve at block 38. For example, if one or more peaks is identified as being out of alignment with other peaks, then the one or more pI markers corresponding to the one or more peaks out of alignment can be removed.

In some examples, if the quality of the fit is still poor following a first removal in block 38, the technique can be repeated to potentially remove another point (e.g., by applying a more restrictive thresholding process and/or varying the definition of “fit”). If removal of a predetermined number of points does not result in a suitable level of quality for the fit (e.g., the number of acceptable points is below a threshold value) in block 40, the process can raise an error state in block 42. This may include returning to block 22 to request a new run, and/or inform the operator of the discrepancy.

Once an acceptable calibration curve has been calculated, the X-axis of the one or more electropherograms of interest can be converted from time to pI, in block 44. In some examples, the operator may select from a variety of outputs (e.g., presentation of a “total ion” and/or selected specific mass/charge associated with the electropherograms). For instance, in optional block 46, a graphical representation of the one or more pI markers along a first axis (X-axis) versus intensity along a second axis (Y-axis) can be generated, and the graphical representation can be presented or displayed to the operator (e.g., with user interface 114 of FIG. 21) in optional block 48.

FIG. 21 provides a diagram of a mass spectrometer (MS) 100 that includes control circuitry or a processing system 102 configured to control one or more components of the MS 100 to implement one or more of monitoring, measuring, analyzing, and/or generating an output corresponding to a calibration operation as disclosed herein. In some examples, the control circuitry 102 includes or is otherwise in communication with a processor 104, a memory storage device 106, a network interface 112, a user interface 114, and/or other circuitry to implement the calibration operation and/or control the MS 100.

In some examples, the memory 106 includes one or more of calibration instructions 108, configured to control actions associated with a calibration operation, and/or a list and/or data library 110 for reference to markers, calibration peptides, pI values, charge and/or isotope values, as a listing of non-limiting examples. In some examples, the control circuitry 102 is connected to one or more remote computers 118, such as via network 116. The remote computers 118 may contain additional information, updates, and/or computing resources, to aid in a calibration operation.

In some examples, the instructions and/or list may be accessed via the network 116. Although disclosed with reference to one or more example systems or methods, calibration operations may be performed using additional or alternative systems, such as employing data from artificial intelligence and/or machine learning systems, as a list of non-limiting examples.

The present method and/or system may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system, such as control circuitry 102 of FIG. 21, or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present disclosure has been described with reference to certain embodiments, it will be understood by those skilled in the art that various changes may be made and equivalents may be substituted without departing from the scope of the present disclosure or appended claims. In addition, many modifications may be made to adapt a particular situation or material to the teachings of the present disclosure without departing from its scope. Therefore, it is intended that the present disclosure not be limited to the particular embodiments disclosed, but that the present disclosure will include all aspects falling within the scope of the appended claims.

All patents, patent applications, publications, and descriptions mentioned above are herein incorporated by reference in their entirety.

1. A method for performing calibration of isoelectric point (pI) markers in mass spectrometry (MS) detection, the method comprising:
generating an output that includes one or more pI markers associated with a sample from MS data performed on the sample;
identifying the one or more pI markers in the output;
identifying one or more of an isotope or a charge state associated with the one or more pI markers; and
correlating time values to the identified one or more pI markers based on the identified isotope or charge state.

2. The method of claim 1, further comprising spiking the sample with the one or more pI markers associated with one or more reference compounds.

3. The method of claim 1, further comprising:
generating a graphical representation of the identified one or more pI markers along a first axis versus intensity along a second axis according to the correlated time values; and
displaying the graphical representation on a user interface.

4. The method of claim 1, wherein identifying the one or more of the isotope or the charge state associated with the one or more pI markers further comprises extracting XIC values for the isotope or the charge state.

5. The method of claim 1, further comprising correlating a plurality of peaks in MS analysis data with one or more of the identified isotope or the charge state with one or more of the time values.

6. The method of claim 1, wherein the pI marker corresponds to an overlapping peak of one or more traces associated with a compound.

7. The method of claim 6, wherein identifying the one or more pI markers in the output further comprises:
identifying one or more peaks of the plurality of peaks associated with the one or more pI markers in alignment with another peak of the plurality of peaks; and
identifying a first pI marker of the one or more pI markers based on a time or intensity value corresponding to the aligned peaks.

8. The method of claim 7, further comprising:
identifying one or more peaks of the plurality of peaks associated with the one or more pI markers out of alignment with other peaks of the plurality of peaks; and
removing the one or more pI markers corresponding to the one or more peaks out of alignment from the output.

9. The method of claim 8, wherein alignment is determined by comparing the intensity values corresponding to the peaks to one or more alignment threshold amounts.

10. A method for performing calibration of compound markers in mass spectrometry (MS) detection, the method comprising:
performing MS analysis on a sample;
generating an output that includes one or more compound markers associated with the sample;
identifying the one or more compound markers in the output;
identifying one or more of an isotope or a charge state associated with the one or more compound markers; and
correlating time values to the identified one or more compound markers based on the identified isotope or charge state.

11. The method of 1, further comprising spiking the sample with peptide markers or one or more compound markers associated with one or more reference compounds.

12. The method of claim 1, further comprising:
applying one or more filters to identify one or more outlier calibration points in the output; and
removing the one or more outlier from the output prior to identification of the one or more pI markers.

13. The method of claim 1, further comprising displaying the isotope or the charge state associated with the identified one or more pI markers or the one or more compound markers in the graphical representation according to the correlated one or more time values.

14. The method of claim 1, wherein the list of compound markers or the list of one or more pI markers comprises one or more calibration peptides.

15. The method of claim 1, wherein the sample contains one or more proteins.

16. The method of claim 1, wherein the method employs a capillary isoelectric focusing-mass spectrometry (CiEF-MS) device.

17. The method of claim 1, wherein the method employs a Capillary electrophoresis-mass spectrometry (CE-MS) device.

18. A capillary isoelectric focusing-mass spectrometry (CiEF-MS) device coupled to a processing system for performing calibration of isoelectric point (pI) markers, the device comprising:
control circuitry configured to:
activate the CiEF to perform analysis on a sample;
activate the MS to perform MS analysis on a sample;
receive output MS data corresponding to the MS analysis;
identify one or more pI markers in the output data associated with the sample;
identify one or more of an isotope or a charge state associated with the one or more pI markers; and
correlate time values to the identified one or more pI markers based on the identified isotope or charge state.

19. The device of claim 18, further comprising a user interface configured to display a graphical representation of the identified one or more pI markers along a first axis according to the correlated time values and intensity values associated with the one or more pI markers along a second axis.

20. The device of claim 18, wherein the pI marker corresponds to an overlapping peak of one or more traces associated with the sample.
